(19) United States
(12) Patent Application Publication
(10) Pub. No.: US 2014/0352732 A1
(43) Pub. Date: Dec. 4, 2014

(54) SOLIDS REMOVAL APPARATUS

(71) Applicants: David Panton Fleming, Brechin (GB); Jack Knertson Flett Davidson, Fraserburgh (GB)

(72) Inventors: David Panton Fleming, Brechin (GB); Jack Knertson Flett Davidson, Fraserburgh (GB)

(73) Assignee: NATIONAL OILWELL VARCO, L.P., Houston, TX (US)

(21) Appl. No.: 13/817,129

(22) PCT Filed: Aug. 15, 2011
(86) PCT No.: PCT/EP2011/064018

§ 371 Date: Aug. 26, 2013

(30) Foreign Application Priority Data
Aug. 16, 2010 (EP) 10172955.6

(51) Int. Cl. B08B 9/093

(52) U.S. Cl. CPC B08B 9/0933
USPC 134/22.18; 134/166 R

(57) ABSTRACT

An apparatus for cleaning a vessel, the apparatus comprising: a housing (1) having an inlet (27) for receiving a pressurised fluid and an outlet (2) for fluidly connecting the housing to the vessel; a cleaning apparatus arranged to spray pressurised fluid inside the vessel; an outlet for fluid returning from the vessel; and flow control means for controlling the supply of pressurised fluid to the housing and cleaning apparatus and the flow of fluid returning from the vessel through the outlet such that a pressure envelope can be maintained around the housing and vessel.

The present invention relates to apparatus for removal of solids, such as sand, from a vessel. In particular, the present invention provides an apparatus and method for flushing solids out of a vessel using a pressurised fluid.

An existing system for flushing out solids from a vessel includes an apparatus which inserts a flushing nozzle into the vessel and sprays out a pressurised fluid to fluidise solids in the vessel, which are then extracted through the apparatus and into an external collection system.

When performing the solids removal process, when an abnormality occurs, it is desirable to be able to isolate the vessel and system from upstream and downstream equipment until any issues have been determined and resolved before recommencing the process. However, a problem with the existing system is that, when an abnormality occurs during operation, a complex system physically severs the pressurised fluid feed line into the vessel in order to isolate it.

As a result of this physical isolation process, however, solids can no longer be removed from the vessel until it is brought offline and intrusively entered to remove the severed feed line and nozzle and a new pressurized feed line and nozzle inserted. This can result in long periods of down-time and increases the cost of the cleaning process.

In addition, existing systems are large and require a lot of deck space on an offshore platform, and are also heavy, which makes them difficult to handle.

According to the present invention there is provided an apparatus for cleaning a vessel, the apparatus comprising:

a housing having an inlet for receiving a pressurised fluid and an outlet for fluidly connecting the housing to the vessel;

a cleaning apparatus arranged to spray pressurised fluid inside the vessel;

an outlet for fluid returning from the vessel; and flow control means for controlling the supply of pressurised fluid to the housing and cleaning apparatus and the flow of fluid returning from the vessel through the outlet such that a pressure envelope can be maintained around the housing and vessel.

According to the present invention there is also provided a method for cleaning a vessel containing solids, comprising:

fluidly connecting a housing containing cleaning apparatus to a vessel to be cleaned;

deploying the cleaning apparatus into the vessel;

pressurising the housing with a fluid such that the internal pressure in the housing is greater than the external pressure;

providing pressurised fluid to the cleaning apparatus to flush out solids from inside the vessel; and

providing flow control means for preventing the flow of fluid into the housing or cleaning apparatus and isolating the flow of fluid returning from the vessel such that a pressure envelope can be maintained around the housing and vessel.

The apparatus of the present invention allows the removal of solids from a vessel in a non-intrusive manner whilst maintaining a pressure envelope outside the vessel. Thus, the apparatus of the present invention is designed to withstand a required pressure of the overall system so that the vessel is not required to be physically isolated by cutting the feed line to it should a problem occur during operation.

The lack of physical cut-off allows the system to be reused after the problem is overcome because no intrusion into the vessel is necessary to remove cut-off parts and hence the vessel can remain on-line at all times.

Furthermore, the fluid feed line into the vessel remains intact throughout, which allows cleaning to quickly recommence.

In addition, the apparatus of the present invention is more compact than existing systems and therefore requires less deck space and is easier to handle.

An example of the present invention will now be described with reference to the accompanying figures, in which:

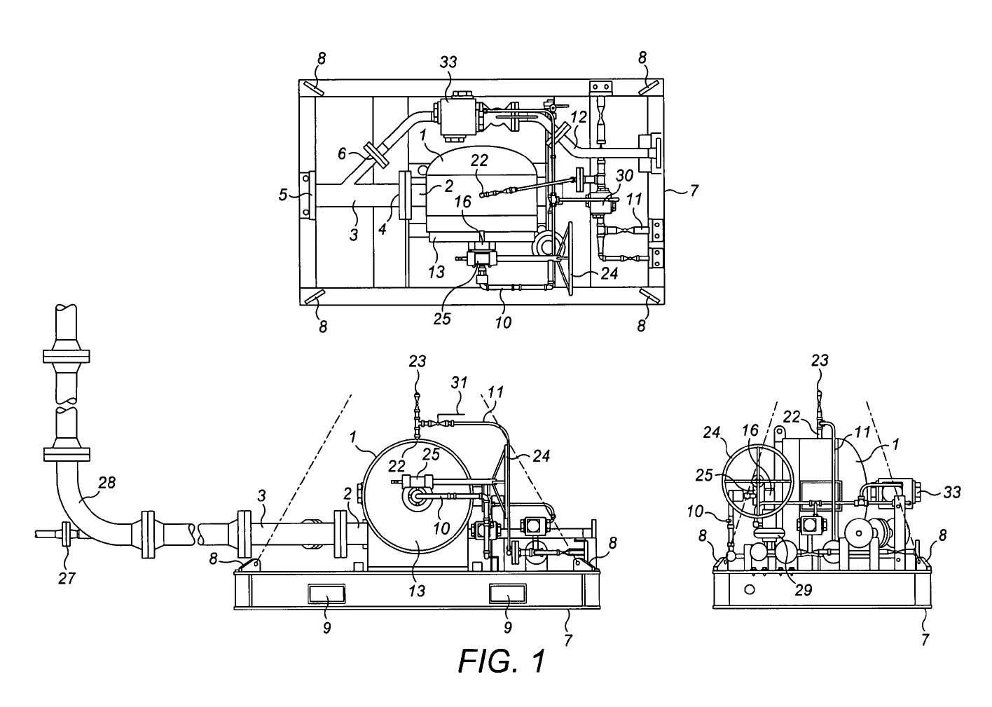

FIG. 1 shows an external view of an apparatus according to the present invention;

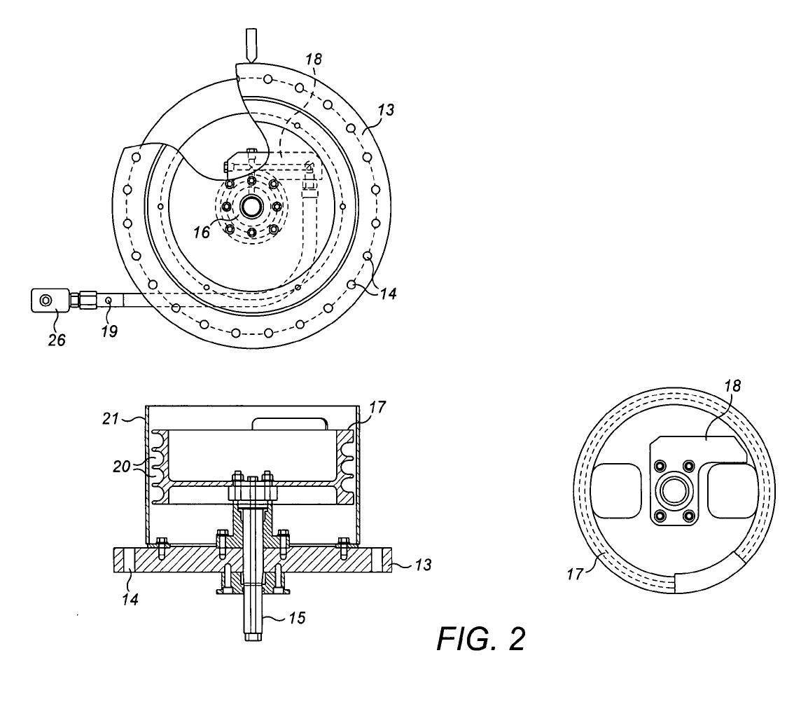

FIG. 2 shows a cover plate removed from the housing, with a reel attached;

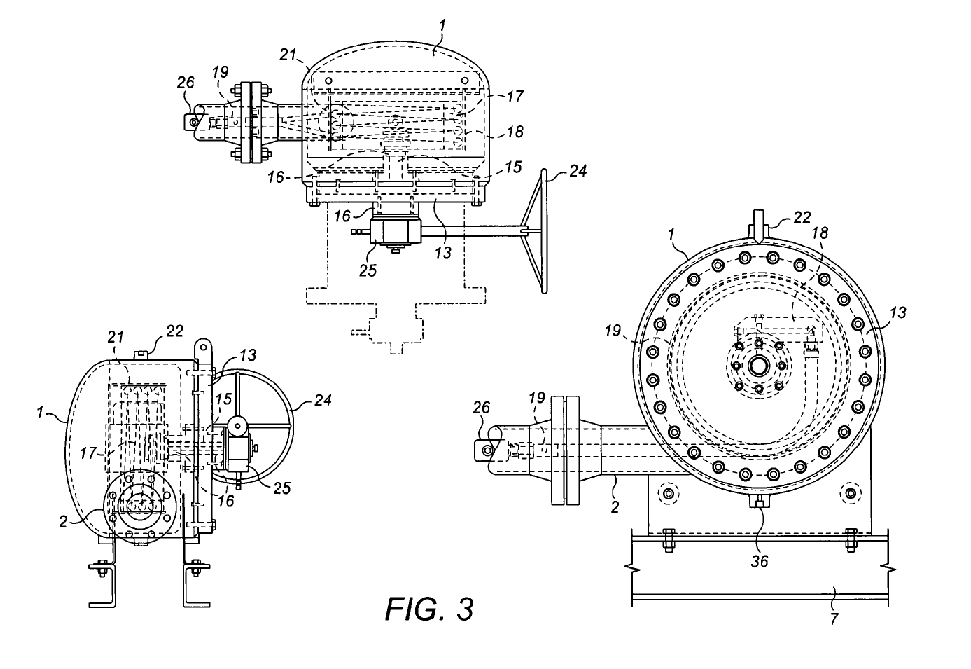

FIG. 3 shows the reel housed within the apparatus when the cover plate is fitted to the housing; and

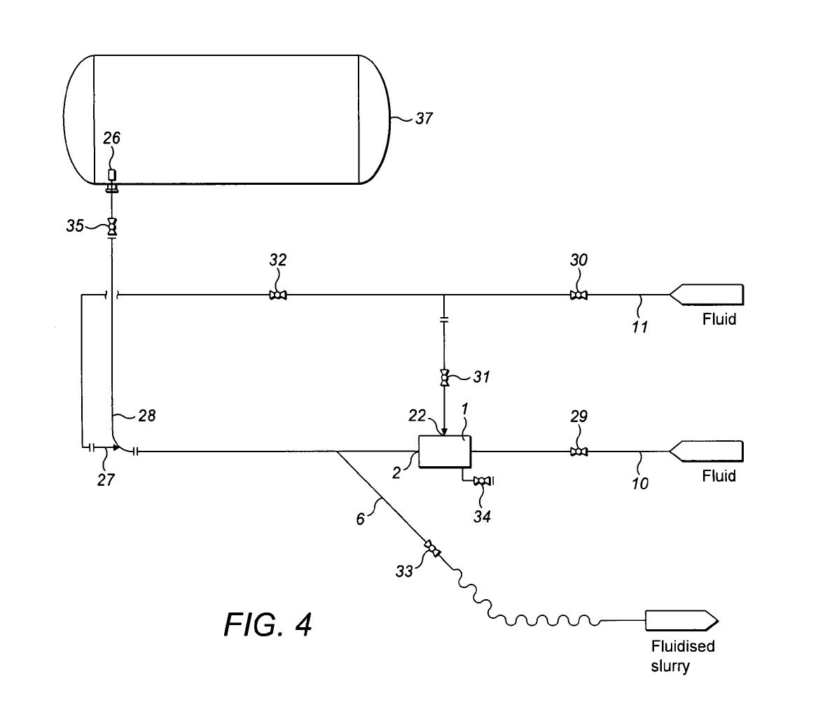

FIG. 4 is a system diagram for an apparatus according to the present invention.

FIG. 1 shows an example of an apparatus according to the present invention, comprising a housing 1 with an external outlet 2 having a first end 4 of an interconnecting pipe 3 attached to it. A second, coaxial, end 5 of the interconnecting pipe 3 is arranged to be connected to a vessel to be cleaned (not shown) via additional pipework. The interconnecting pipe 3 also has a branch portion 6 that extends out from the side of the interconnecting pipe 3 and which acts as a drain outlet for fluid returning from the vessel carrying flushed out solids in the form of slurry.

The apparatus is, preferably, mounted on a pallet 7, or similar, provided to enable easy transportation of the apparatus either by being lifted from above, using suitable lifting equipment and fixing points 8, or by a forklift truck engaging with pockets 9 provided in the pallet 7. Pipe-work 10, 11 for supplying pressurised fluid to the apparatus and drainage pipe-work 12 for the slurry output are also provided on the pallet 7 to effectively provide a self-contained system. The housing 1 is sealed by a cover plate 13 positioned at the front of the housing 1.

FIG. 2 shows the cover plate 13 removed from the housing 1. The cover plate 13 has a plurality of holes 14 spaced around its circumference towards its outer edge for securing it to the housing 1, using suitable means such as bolts or similar. An inlet pipe 15 extends through the cover plate 13, the inlet pipe 15 being supported by a bearing arrangement 16 provided on either side of the cover plate 13 which allows the inlet pipe 15 to rotate. On the housing 1 side of the cover plate 13, the inlet pipe 15 connects to a rotatable reel 17 that is attached to the cover plate 13 via an inner part of the bearing arrangement 16. More specifically, the inlet pipe 15 connects to a drive plate connector 18 that is provided between the reel 17 and the inner part of the bearing 16, the drive plate connector 18 being arranged to rotate the reel 17 with the inlet pipe 15. Upon the reel 17 is stored a length of tubing 19, a first end of which is fluidly connected to the drive plate connector 18 and hence the inlet pipe 15.

The reel 17 is provided with grooves 20 that are configured in a helical fashion to accept the tubing 19 when being wound onto the reel 17. A reel housing 21, which is secured to the cover plate 13, is configured to closely encase the reel 17 such that the tubing 19 is retained within the grooves 20 and cannot cross between them at any point, thus ensuring that the tubing 19 does not become entangled and providing a smooth winding motion for the reel 17.

The end of the inlet pipe 15 that protrudes outside of the housing 1 is arranged to be connected to a fluid source that can supply a fluid under pressure to the tubing 19 via tubing inlet pipework 10.

Referring again to FIG. 1, a further housing inlet 22 for pressurised fluid is provided on the housing 1 for supplying pressurised fluid into the housing 1 itself, via external pipework 11. The fluid inlet 22 is provided with a vent 23 to allow excessive pressure to be relieved from the housing 1, if necessary.

External to the housing, a hand wheel 24, or similar, is arranged to engage with the inlet pipe 15 via a gearbox 25, or similar, such that rotation of the hand wheel 24 causes the inlet pipe 15 to rotate, which in turn causes the reel 17 to rotate, thereby deploying or retracting the length of tubing 19 stored thereon.

The second, free end of the tubing 19 is provided with a nozzle attachment 26, which is configured to eject pressurised fluid as a spray. When the apparatus is not in use, the nozzle 26, preferable, rests in the interconnecting pipe 3, just outside of the outlet 2.

A seal (not shown), is, ideally, provided at the outlet 2 to preventing any debris that has become attached to the tubing 19 from entering the housing 1. In other words, the tubing 19 is cleaned before it is stored on the reel 17. An example of a suitable seal is an arrangement of stiff bristles secured around a ring that is arranged to cover the mouth of the outlet 2 on the inside of the housing 1, with the bristles extending towards the centre of the ring such that, as the tubing 19 is retracted, any debris attached to the tubing 19 is dislodged by the bristles of the seal and flushed away through the branch outlet 6.

When the hand wheel 24 is rotated in a “deploying” direction, the tubing 19 is deployed out of the interconnecting pipe 3 and through any attached pipework into the vessel to be cleaned. The length of the tubing 19 is, ideally, configured to be of sufficient length to reach a vessel connected to the apparatus, while not being so long that it will buckle or twist within the pipework or vessel as it is unwound. As an example, tubing 19 with a length of 3 m is believed to be suitable, although different lengths can of course be used.

Ideally, a suitable measuring apparatus, such as a mechanism (not shown) provided in the gearbox 25 to measure angular rotation, will be provided to monitor the length of tubing 19 deployed from the reel 117 so that an accurate position of the nozzle 26 inside the pipework or vessel to be cleaned can be determined by a simple comparison of the length of tubing 19 deployed with the known distance from the outlet 2 to the vessel. This ensures that optimised cleaning of the vessel can be achieved in an efficient manner.

FIG. 3 shows the reel 117 installed within the housing 1 with the tubing 19 stored on the reel 117 in an un-deployed state. The nozzle 26 attached to the free end of the tubing 19 can be seen at rest in the interconnecting pipe 3, just outside the outlet 2. As described above, the tubing 19 is deployed by turning the hand wheel 24, which is attached to the gearbox 25 such that rotation of the hand wheel 24 causes the inlet pipe 15 to rotate, which in turn causes the reel 117 to rotate, thereby deploying the tubing 19 stored on it.

Accordingly, in use, the housing 1 is connected to a vessel to be cleaned via the outlet 2, interconnecting pipe 3 and any other pipework that might be necessary to bridge the gap between the vessel and the interconnecting pipe 3. The tubing 19 is then deployed through the pipework until the nozzle 26 reaches the vessel to be cleaned. Once in position, pressurised fluid is pumped through the tubing 19 and sprayed out through the nozzle 26 to dislodge any debris from the inside walls of the vessel. The debris is carried away from the vessel as slurry through the pipework towards the housing, where it exits the pipework via the branch portion 6 of the interconnecting pipe 3.

The fluidising medium, for example water, is provided to the nozzle 26 at a pressure that is sufficient to break down solids that have been deposited in the vessel, a suitable pressure being considered to be between around 3.447 MPa (500 psi) and 103.421 MPa (15000 psi), for example.

A flushing fluid inlet 27 is, preferably, provided along the pipework, configured so that flushing fluid can be introduced into the pipework in a direction away from the vessel and back towards the branch outlet 6 to help flush out and dilute broken down solids deposited in the pipe work by the slurry thereby preventing any blockages. The flushing fluid inlet 27 is, ideally, provided on a second interconnecting pipe 28 configured to have a bend, such as the one shown in FIG. 1. Any downstream treatment system that the slurry is directed into may also benefit from the dilution.

Pressurised fluid is provided to the housing 1 through the housing inlet 22, and also to the flushing fluid inlet 27, via pipework 11. The pressure of the fluid provided by pipework 11 should be sufficient to create a positive pressure differential at outlet 2 to prevent any fluid returning from the vessel, carrying debris in the form of slurry, from entering the housing 1.

FIG. 4 is a system diagram showing how the exemplary apparatus of FIG. 1 can be controlled. The control of fluid into the system, or the drainage of the slurry out of the branch outlet 6 can be achieved by an arrangement of valves. In the exemplary system shown, a first inlet valve 29 is provided to control the flow of fluid into the tubing 19 to be sprayed inside the vessel 37 by the nozzle 26 and, similarly, a second inlet valve 30 can be used to control the flow of pressurised fluid to the housing 1 and also the flushing fluid inlet 27. Supply of pressurised fluid to the housing 1 and the flushing fluid inlet 27 can further be individually controlled by housing valve 31 and flushing fluid inlet valve 32, respectively, downstream of the second inlet valve 30.

Drainage of waste fluid, or slurry, returning from the vessel 37 and out through the branch outlet 6 can be controlled using the waste valve 33 to isolate solids removal from the vessel 37. A housing drainage outlet 36 is also provided in the housing 1 to allow it to be drained when necessary. In addition, the outlet of the vessel 37 itself has a vessel valve 35 for controlling the flow of fluids in and out of it.

To provide pressurised fluid to the housing 1 via the housing inlet 22 the sequence of steps is as follows. First the tubing 19 is deployed through the outlet 2 and connecting pipework until the nozzle 26 reaches the vessel valve 35. The flow path for the slurry is then established by opening waste valve 33 before the housing valve 31 and, optionally, the flushing fluid inlet valve 32 are opened to pressurize the system. The vessel valve 35 is then opened and the tubing 19 and nozzle 26 further deployed into position inside the vessel 37 before spraying of the inside of the vessel 37 is commenced by opening the first inlet valve 29 to supply pressurized fluid to the nozzle 26.

All of the above-described valves and pipework, with the exception of the vessel valve 35, can be provided on the pallet 7, together with the housing 1, to provide a highly mobile modular apparatus.

In the event of an emergency with the system, first and second inlet valves 29, 30 and waste valve 33 can all be closed, thereby maintaining a pressure envelope around the apparatus and connected vessel 37, which avoids the need to otherwise cut the tubing 19 to isolate the vessel 37, to protect any waste receiving equipment (not shown) provided downstream of the waste valve 33.

1. An apparatus for cleaning a vessel, the apparatus comprising:
a housing having an inlet for receiving a pressurised fluid and an outlet for fluidly connecting the housing to the vessel;
a cleaning apparatus arranged to spray pressurised fluid inside the vessel;
an outlet for fluid returning from the vessel; and
flow control means for controlling the supply of pressurised fluid to the housing and cleaning apparatus and the flow of fluid returning from the vessel through the outlet such that a pressure envelope can be maintained around the housing and vessel.

2. The apparatus of claim 1, wherein the cleaning apparatus is contained within the housing and is arranged to retractably deploy the cleaning apparatus via the housing outlet.

3. The apparatus of claim 1, further comprising an interconnecting pipe for connecting between the housing outlet and a vessel, the interconnecting pipe having a branch portion for fluid returning from the vessel containing solids to be drained.

4. The apparatus of claim 1, wherein the cleaning apparatus comprises a length of tubing having a nozzle at one end, configured to spray pressurised fluid.

5. The apparatus of claim 1, further comprising a storage means, wherein the storage means is a rotatable reel having grooves formed in a helical fashion for receiving the tubing and the apparatus further comprises a heel housing arranged to fit closely over the reel to ensure that the tubing is retained within the grooves.

6. The apparatus of claim 1, wherein the housing and outlet are configured to have a pressure rating similar to that of the vessel to be cleaned.

7. The apparatus of claim 1, further comprising a sealing means provided at the housing outlet and arranged to prevent any solids returning from the vessel from entering the housing.

8. The apparatus of claim 5, further comprising a measuring means to determine the length of tubing deployed from the storage means.

9. The apparatus of claim 5, further comprising a hand wheel connected to the rotatable reel and arranged such that rotation of the hand wheel causes the reel to rotate, thereby deploying or retracting the tubing, depending on the direction of rotation.

10. The apparatus of -claim 1 further comprising a pallet upon which the housing is mounted, the pallet being configured for transporting the apparatus.

11. A method for cleaning a vessel containing solids, comprising:
fluidly connecting a housing containing cleaning apparatus to a vessel to be cleaned;
deploying the cleaning apparatus into the vessel;
pressurising the housing with a fluid such that the internal pressure in the housing is greater than the external pressure;
providing pressurised fluid to the cleaning apparatus to flush out solids from inside the vessel; and
providing flow control means for preventing the flow of fluid into the housing or cleaning apparatus and isolating the flow of fluid returning from the vessel such that a pressure envelope can be maintained around the housing and vessel.

12. The method of claim 11, further comprising the step of: providing an interconnecting pipe between the vessel and the housing,
wherein the interconnecting pipe has both coaxial outlets and also a branch portion arranged to allow fluid returning from the vessel to exit the interconnecting pipe.

13. The method of claim 11, further comprising the step of flushing additional fluid into the interconnecting pipe from a flushing inlet in a flow direction away from the vessel to improve the removal of solids from the interconnecting pipe.

14. The method of claim 11, wherein the cleaning apparatus is a length of tubing having a nozzle for spraying pressurised fluid into a vessel, the tubing being stored in the housing on a rotatable reel.

15. The method of claim 11, wherein the cleaning apparatus is retractably deployed by rotating a hand wheel external to the housing.
